(19) United States
(12) Patent Application Publication
(10) Pub. No.: US 2003/0142696 A1
(43) Pub. Date: Jul. 31, 2003

(54) Method for ensuring access to a transmission medium

(76) Inventors: Oyvind Holmeide, Oslo (NO); Lennart Liljestrom, Vasteras (NO)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,411

(22) PCT Filed: Jun. 6, 2001
(86) PCT No.: PCT/NO01/00233

(30) Foreign Application Priority Data
Jun. 6, 2000 (NO) 20002883

(51) Int. Cl. H04J 3/06

(52) U.S. Cl. 370/508; 370/518

(57) ABSTRACT

The present invention relates to a method for ensuring access to a transmission medium at a predetermined point in time, for transmission of a data packet. This is achieved by making one or more communication pons on which the packet is to be transmitted unavailable for conflicting traffic for a period of time that is set to expire at the desired point in time, and preparing the data packet to be transmitted as soon as said communication port again is made available. Also described is a time server for distributing time information packets utilizing the method.

The invention concerns a method for ensuring access to a transmission medium at a predetermined point in time. More specifically the invention relates to a method for including a time stamp in a data packet, where said time stamp indicates the time of a local clock at the moment said packet is transmitted. The invention also relates to a time server using said method to distribute time information packets on a computer network.

When a plurality of computer systems are connected over a computer network it is often of great importance that the respective systems' local clocks are synchronized. This is particularly important in communication in substation automation applications in high and medium voltage power girds, where raw data is sent from producer to receiver nodes. Other examples include real time systems like process control systems where the respective parts of the system necessarily must operate on a common time reference. Multimedia applications and standard office networks also require synchronized clocks.

In order to achieve this it has been common that communication in particularly critical systems has been based on expensive communication systems with separate lines, such as fiber optics, only used for the distribution of time information.

There has also been developed standards that aim to improve the exchange of time information over the same computer network as other data communication is transported. Examples include RFC 1305—Network Time Protocol (NTP) and RFC 2030—Simple Network Time Protocol (SNTP). Briefly described, the latter is based on a client requesting a time update from a time server, where the time server receives timing signals from a very accurate source such as GPS (Global Positioning System) or an atomic clock. The time request being sent to the server includes a time stamp T1 indicating when the packet was sent from the client according to the client's local clock. As a reply to the request the server transmits a reply packet back to the client. The reply packet includes two time stamps, T2 and T3, where T2 is the time the request was received by the time server and T3 is the time the reply packet was sent from the time server. When the client receives the reply from the time server it determines a time of arrival, T4, for the reply. It can be seen that out of these four time stamps, T1 and T4 are based on the local clock of the client, while T2 and T3 are according to the local clock of the time server.

Based on these time stamps the client is able to calculate the following

d=(T4−T1)−(T3−T2) (1)

and

t=((T2−T1)+(T3−T4))/2 (2)

where

d is the round trip delay, and

t is the local clock offset.

This method suffers from a number of weaknesses. We will assume that the client and the server are connected over only one link so that the propagation time between them remain constant. The inclusion of additional network elements such as switches between the client and the server would add inaccuracies to the method. However, other inaccuracies are related to the registration of the different time stamps. Regarding T1 it is important that the packet does not remain in queue for transmit after T1 has been registered. This problem can be alleviated in several ways, e.g. by using the time stamp T1 only as a reference time stamp while registering in the client the local clock time T1′ when the packet actually is transmitted. Regarding T2 there are several possibilities. If the server is able to register T2 immediately as the packet arrives at the server's Ethernet controller, an exact time stamp can be achieved. But if the packet must traverse the Ethernet driver and the entire UDP/IP protocol stack before being registered by the server application itself, the time stamp will be much less accurate. Regarding T3 the problem is similar to the problem described in relation to T1. In this case it is not possible to use the same method as described in relation to T1. If T3 is delayed in the server's output buffer after the time stamp T3 has been determined, T3 will be inaccurate. And since the client bases the update of its own local clock on the contents of the reply packet, the problem can not be alleviated by registering in the server when the packet is actually sent. T4 is less problematic. Since the client is expecting a reply it will be able to monitor its input ports and register the arrival of the reply packet with great accuracy.

U.S. Pat. No. 5,481,258 describes a distributed system, particularly a paging system, comprising a system controller and a plurality of distributed paging stations. The paging stations coordinate their respective clocks through timing information transmitted from the system controller. The system controller transmits a time mark, and at a future time it transmits the time mark send time. Each receiving paging station registers the time at which the time mark arrived according to its own local clock and they measure the time interval between the time at which the time mark arrived and the time at which the time mark was transmitted by the system controller. By subtracting the time at which the time mark was transmitted by the system controller and the propagation time to the respective paging station, each paging station can determine and correct the error in its own clock.

U.S. Pat. No. 4,815,110 describes a method for synchronizing clocks in a bus type local network, such as Ethernet. The method is based on letting one unit on the network operate as a master node. From the master node a synchronizing message is transmitted, addressed to all the nodes, including the master node. All the nodes then register the time at which the synchronizing message is received. Then the master node transmits a clock time message containing the master node clock state when it received the synchronizing message. The respective slave nodes will compare the received master clock state with the clock states which have been read in the slave nodes and correct their local clocks in accordance with the results of this comparison.

This method is advantageous if all the slave nodes are connected directly to the same bus or to a hub based Ethernet network. The only difference in time for the registration of the synchronizing message at the master node and at the slave nodes will be the difference in propagation delay. This difference will be static and may be corrected through calibration. The same is not the case in a network structure based on switches. If there is only one switch between the master node and the slave nodes and the switch is based on so called “shared memory” architecture, the delay through the switch will be the same for the master node and all the slave nodes. However, if there are several switches between the master node and the slave nodes, or if the switch is not of the “shared memory” type, the delay will be variable. Because of this, this method has limited scalability.

Another disadvantage with the methods described above is that they require an additional message to be sent from the time server after the transmission of the time mark, or synchronizing message. This means that none of the messages can be utilized in accordance with the NTP/SNTP standards without modifying these standards.

It is therefor an object of the invention to provide a method for distributing time information on a computer network where the problems and disadvantages described are addressed.

In particular it is an object of the invention to provide a method for ensuring access to a transmission medium at a predetermined point in time.

More specifically it is an object of the invention to provide a method for providing a packet with a time stamp that with great accuracy indicates the time, according to a local clock, at which the packet was transmitted.

It is a further object of the invention to achieve distribution of time information in switched Ethernet with an accuracy that makes such networks a viable alternative to networks with fixed time slots. Profibus and MVB are examples of network implementations with fixed time slots. A relevant real time system that requires accurate time synchronization via its communication infrastructure is High Voltage (HV) substation automation system.

The advantage of real time systems with fixed time slots is that the arrival time of data packets is deterministic. This will not be the case in networks with the type of access control used in networks such as IEEE 802.3 (Ethernet). It is, however, possible to overcome this problem by making sure that each packet with measurement data contains an accurate time stamp indicating when the measurement was performed. The problem is then reduced to a problem of synchronization, where the challenge is to synchronize every node in the network where measurements are performed. It should however be pointed out that even though the invention primarily will be described in relation with the synchronization of substations over an Ethernet type network, the invention will be found useful in numerous other applications and in connection with other types of networks.

The stated objects of the invention are achieved through the features described in the independent claims, while advantageous embodiments and additional features are described in the dependent claims.

The object of ensuring access to a transmission medium at a predetermined point in time, where said point in time does not specifically relate to any information contained in the packet to be transmitted, is solved according to the invention as follows. The method is based on making the communication port or ports on which the packet is to be transmitted, unavailable for conflicting traffic for a period of time that terminates at the time on which the packet is to be transmitted. Any ongoing transmission is, however, allowed to continue. As soon as any ongoing traffic is completed on the port or ports in question, a busy signal will be transmitted. During the transmission of the busy signal, the packet or packets are prepared for transmission by being placed in the respective output buffers with highest priority. When the busy signal terminates, the packets will be transmitted following a delay equal to the minimum allowable time gap between packets.

While it can be seen that the features of the invention described above can be applied to any number of applications where it is necessary to ensure access to a transmission medium at a predetermined point in time, the invention is particularly useful as a method for including a time stamp in a data packet, where the time stamp indicates when, according to a local clock, the packet was transmitted. This is particularly useful as a means of distributing time information packets in a computer network for synchronization of local clocks, as will be described further below. This method is in principle similar to the one above, with the addition of adding the time of transmission as a time stamp in the packet. However, since the point in time on which the packet will be transmitted is not critical, as long as it corresponds to the time stamp in the packet, the busy signal does not have to terminate at a predetermined point in time. Instead it can be maintained for a predetermined period of time, and the time stamp can be determined based on the length of this period. This also means that the busy signal does not have to be a signal that can be terminated at any time. It may also be a dummy packet with a fixed length and containing a predetermined pattern which may be detected on the communication port. It should be noted that this alternative is not suited for transmission simultaneously on several communication ports, since it can not be guaranteed that transmission of dummy packets will commence simultaneously on all ports.

Both methods described above are suitable for both full duplex and half duplex. It should be noted, however, that in the case of full duplex it is not necessary to actually transmit a busy signal or a dummy packet in order to occupy the transmission medium, as any incoming traffic will not be in conflict with the transmission of the outgoing packet. In this case it is sufficient to ensure that no new outgoing transmission will have access to the communication ports after any ongoing transmission has been completed. This can be done by disabling the entry of new packets, except for the packet in question, for a period of time that is at least as long as the time it talces to transmit a maximum length packet, and ensure that the packet is given highest priority, or alternatively it can be done by disabling entry of new packets into the output buffer for a period of time that is sufficient to flush the buffer, and thereupon ensuring that the packet in question is the first packet to enter the buffer when entry again is enabled.

A time server operating in accordance with the invention will comprise a processor operating according to instructions in a memory, a local clock, and one or more communication ports with output buffers. Preferably the time server also include input means for receiving time signals from an external clock such as a GPS-receiver or an atomic clock. The time server may further include means for generating and possibly detecting busy signals or dummy packets, and to the extent possible it is preferable that such means are realized as additional instructions to be carried out by the processor.

The invention will now be described in further detail by way of examples, and with reference to the accompanying drawings, where

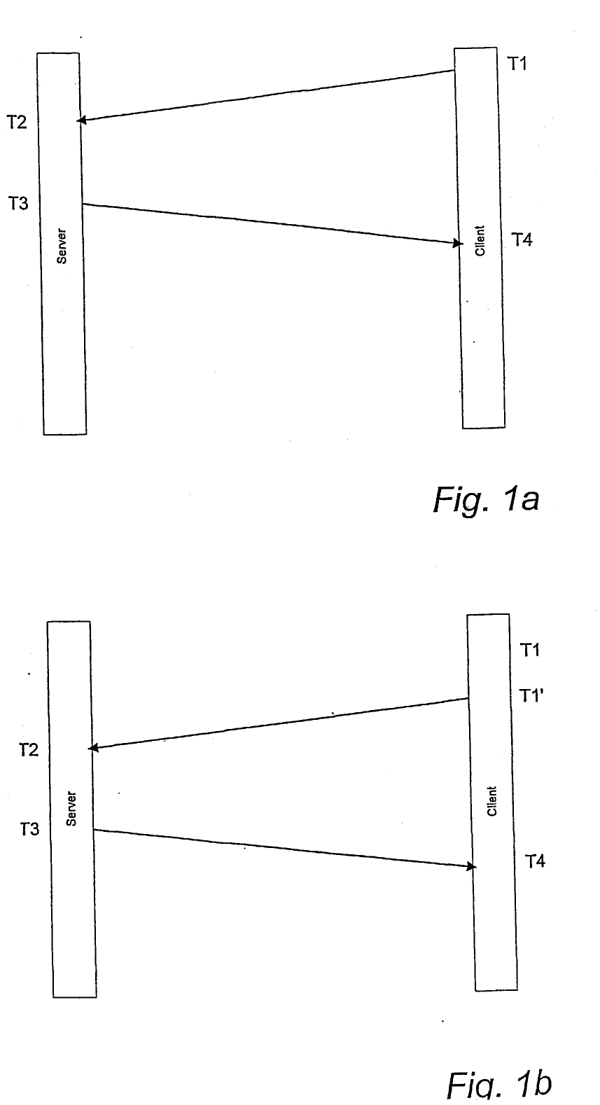

FIG. 1 illustrates the exchange of information in a unicast SNTP time information distrubution,

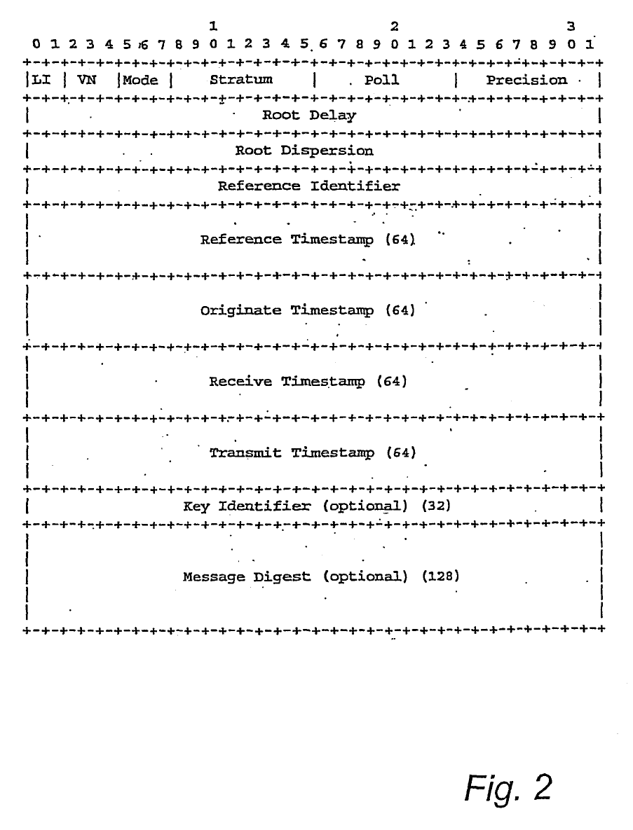

FIG. 2 shows the message format according to SNTP version 4,

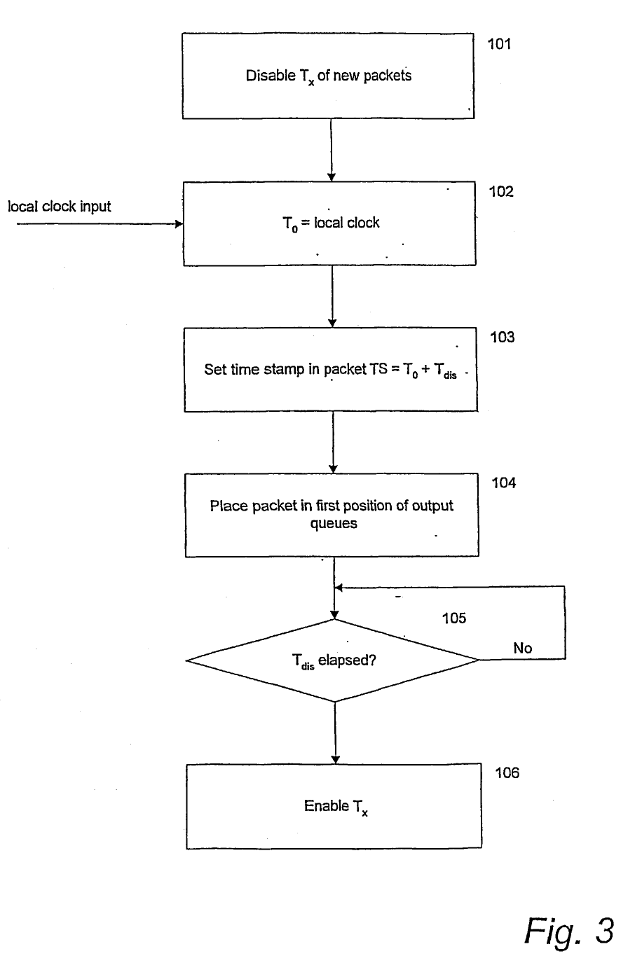

FIG. 3 shows a flow chart illustrating a first embodiment of the invention,

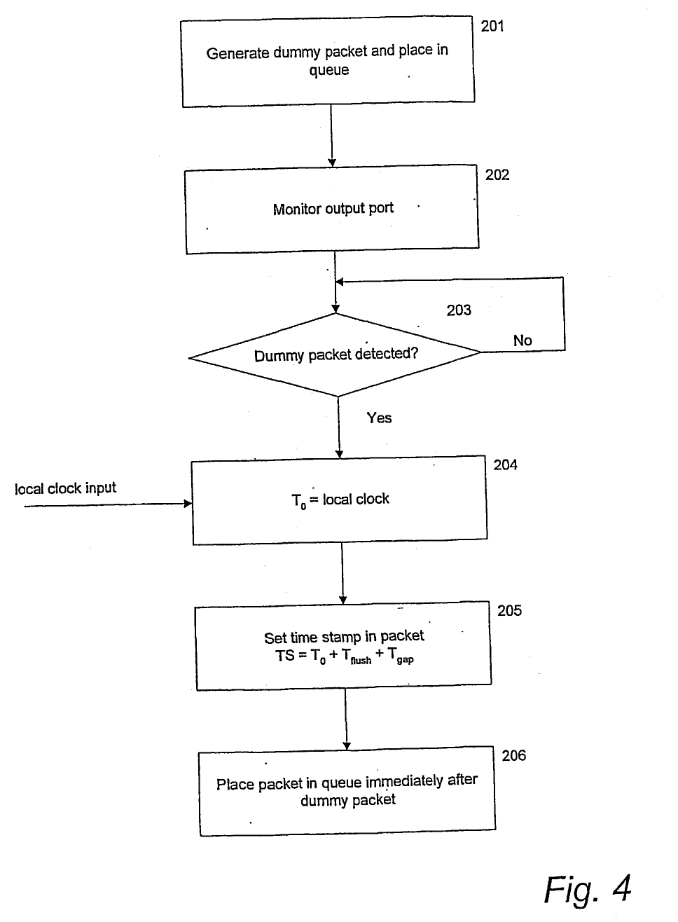

FIG. 4 shows a flow chart illustrating a second embodiment of the invention,

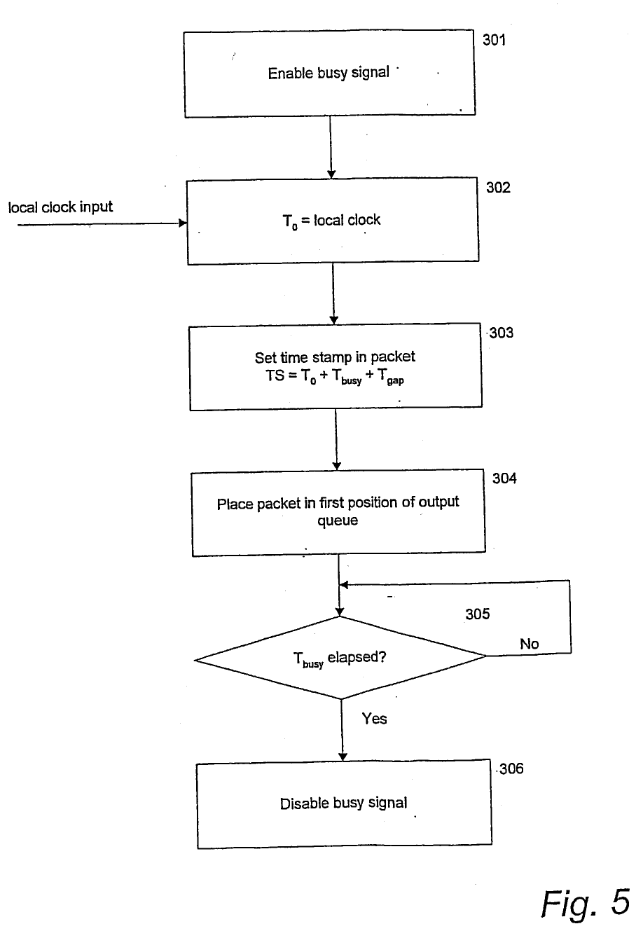

FIG. 5 shows a flow chart illustrating a third embodiment of the invention,

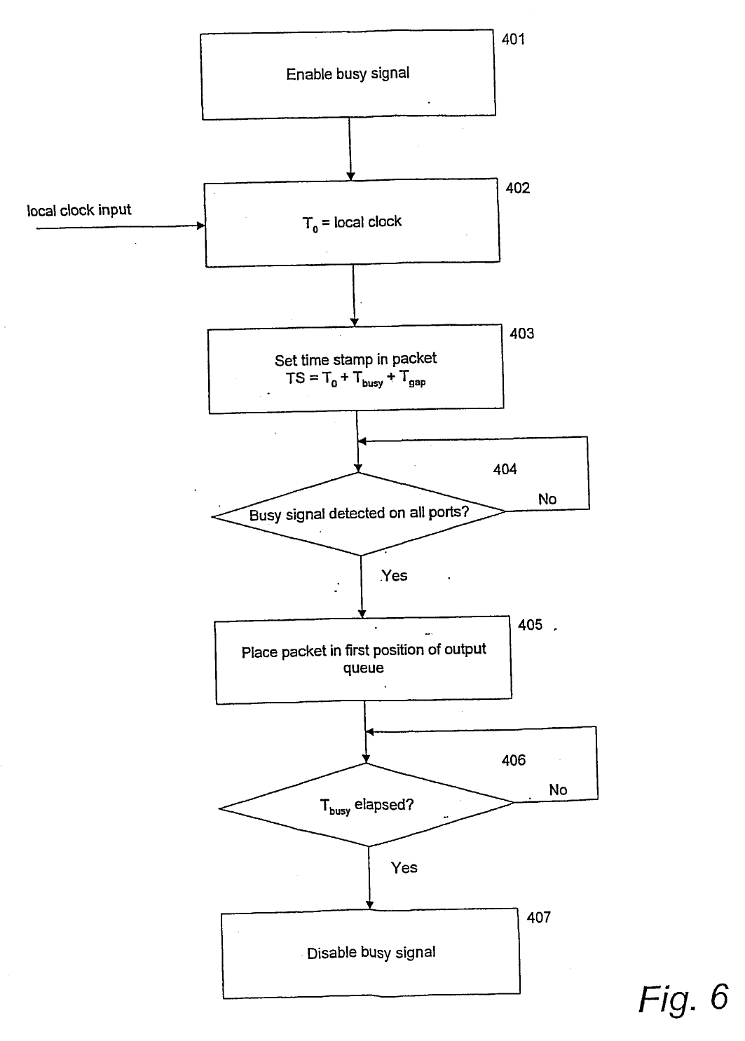

FIG. 6 shows a flow chart illustrating a fourth embodiment of the invention,

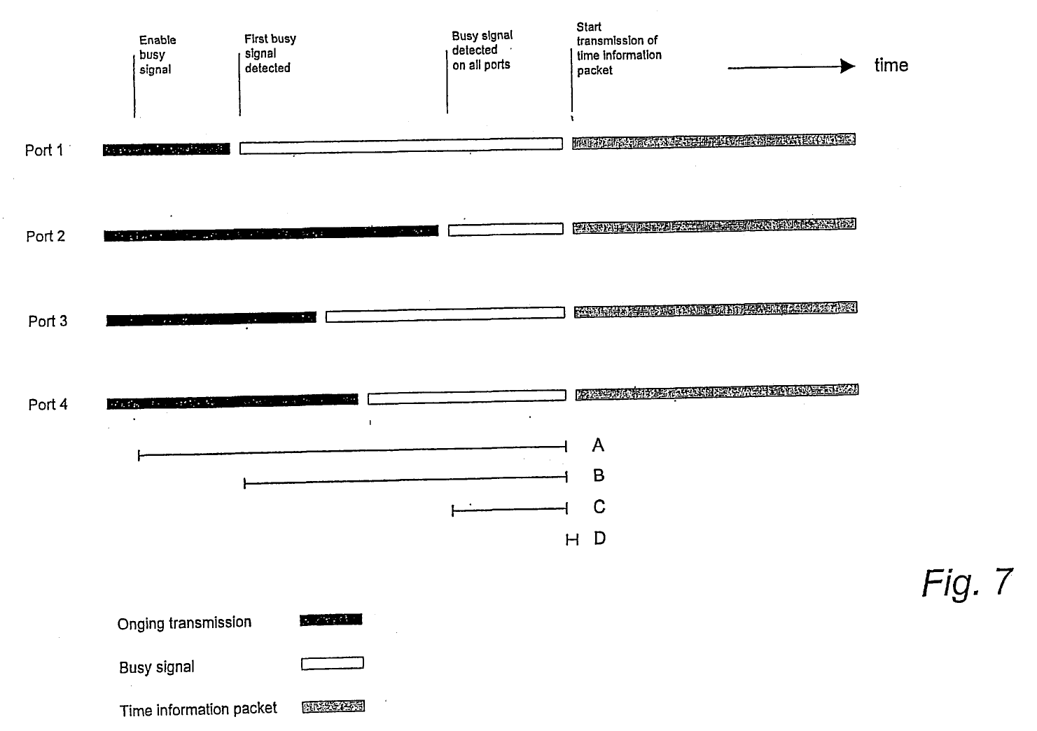

FIG. 7 shows a time line illustrating transmission on a plurality of ports corresponding to the embodiment illustrated in FIG. 6.

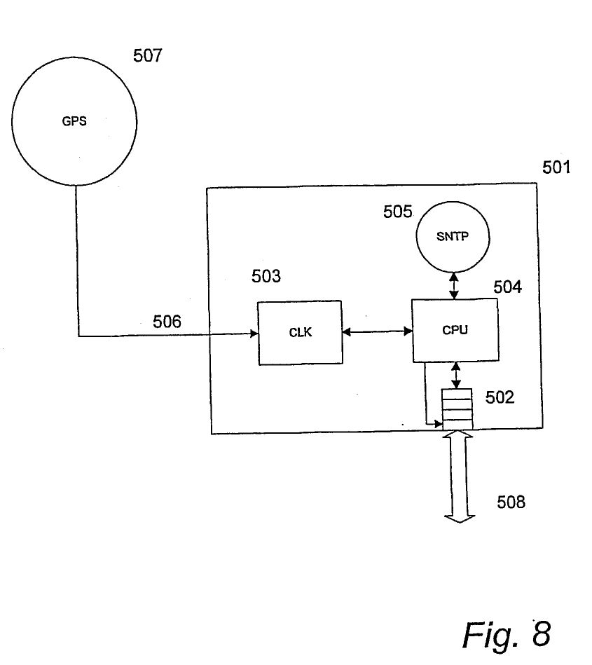

FIG. 8 shows a block diagram of a time server.

The following embodiments of the invention are implementations using the Simple Network Time Protocol. It should be pointed out, however, that although this is a convenient format for time information distribution, the invention is by no means limited to such implementations. Indeed, as has already been mentioned, the invention is not limited to time information distribution, but may equally well be used for other applications where it is necessary to ensure access for a data packet to a transmission medium at a given point in time. For the sake of clarity, however, the following examples all concern time information distribution, as these examples will provide the person of skill with the necessary understanding of how to work the invention in the context of a particularly useful application.

FIG. 1a illustrates the flow of information in a unicast distribution of time information according to the SNTP protocol. At time T1 the client requests time information by sending a packet to the time server. The message format of this packet, which follows the IP and UDP headers, is shown in FIG. 2. All the fields of this message will not be described, reference is made to RFC 2030, Simple Network Time Protocol (SNTP) Version 4, for IPv4, IPv6 and OSI, by D. Mills, University of Delaware, October 1996.

The field denoted “Originate Timestamp” contains a time stamp indicating at which time T1 the request departed the client for the server in 64-bit time stamp format. When the request is received at the time server the time T2 is registered and recorded as a time stamp in the field denoted “Receive Timestamp”. The message is then returned to the client, and the time T3 at which the reply departed the server for the client is recorded in the field called “Transmit Timestamp.”When the reply is received at the client, the client records this time T4. Note that T1 and T4 will be according to the local clock of the client, while T2 and T3 are according to the local clock of the server.

As already described, the round trip delay is then calculated as

d=(T4−T1)−(T3−T2) (1)

and the local clock offset is

t=((T2−T1)+(T3−T4))/2 (2)

It is also possible to calculate the time offset only based on either T1 and T2 or T3 and T4, but only if the propagation delay and any other delays can be compensated for through calibration or are negligible. Systems where timing information is transmitted or broadcast from a time server without any request from the client, such as the system described in the above mentioned U.S. Pat. No. 5,481,258 or SNTP in multicast mode, would correspond to the latter alternative.

Referring now to FIG. 1b, in order to improve the accuracy of this method, it is possible to use the time stamp T1 only as a reference identifying the request, and to register a time T1′ when the request actually leaves the client. This time T1′ will be registered in hardware as exactly as possible and stored in the client. Upon receipt of the reply from the time server the client then substitutes T1′ for T1 and calculates

d=(T4−T1′)−(T3−T2) (3)

and

t=((T2−T1′)+(T3−T4))/2 (4)

respectively.

The accuracy of the time stamps T2 and T4 depends on how exact the server and client respectively are able to detect the time of arrival of a message. This depends on several factors, such as whether the message is detected in hardware at the input port of the unit or if it has to traverse the different protocol layers before being detected by the time server or time client software.

This exemplary embodiment of the present invention is concerned with increasing the accuracy of the time stamp in a message field indicating when the message containing that time stamp was transmitted. We note that there are two such time stamps in the procedure described above, T1 and T3. Since the accuracy of T1 can be improved by replacing it with T1′ as described, the invention is most useful when used to improve the accuracy of T3, but it may equally well be utilized in order to improve T1. As will be realized by anyone of ordinary skill in the art, the method of the invention is equally useful also in other systems that require deterministic access of a packet to a network or other medium that is based on multiple access.

The present invention is based on the principle of creating a time stamp indicating a future time, placing the packet containing the time stamp in an output queue and transmitting the packet when the local clock reaches the time indicated in the packet. In order to be able to do this, however, it is necessary to ensure access to the transmission medium at the right time. The solution to this problem may vary depending on whether the transmission medium is full duplex or half duplex.

Referring now to FIG. 3, a first embodiment of the invention will be described. The embodiment will be described as realized in a time server capable of operating on a full duplex transmission medium. Since the server is capable of operating in full duplex, outgoing transmission will not be prevented by incoming transmission. Hence it is not necessary to prevent any incoming communication on the ports on which the server is preparing to transmit the time information packet. However it is necessary to make sure that the communication port or ports will not be busy transmitting other packets when it is time to transmit the time information packet. This is done by disabling 101 the transmission of new packets on the port or ports on which the time information packet is to be transmitted and at the same time recording the time of the local clock in the time server. Any ongoing transmission of packets, however, is allowed to continue. The length of the period of time transmission is disabled, is set to be longer than the transmission time for a maximum size packet. In this way it is guaranteed that all ongoing transmission will be completed and all the communication ports will be idle before the end of the disable period. Following this, the time of the local clock is read 102. Preferably the local clock is read at the same time transmission is disabled, but this may also be done at a later time, as long as the remaining time of the disable period is known at this time. Based on the registered time of the local clock, a time stamp TS is generated 103. The Transmit Time stamp set equal to the time of the local clock recorded when transmission was disabled plus the length of the disable period, or

TS=T₀+T_{dis} (5)

Where TS is Transmit Timestamp, T₀ is the recorded time of the local clock when transmission is disabled and T_{dis} is the period of time during which transmission remains disabled. A time information packet containing the time stamp is then generated and placed 104 in the first position of the output queues.

After a predetermined time 105, transmission is again enabled 106, and the time update packet will immediately be transmitted on the ports on which it is queued.

According to the Ethernet standard the maximum packet size is 1518 bytes. This means that if the bit rate on the drop links is 100 Mbps, the duration of the disabling of the transmission, T_{dis}, will typically be equal to or larger than 122 μs, while on 10 Mbps drop links T_{dis} will be equal to or larger than 1.22 ms. In order to make sure the time update packet is at the head of the queue when transmission again is enabled, the packet may be given highest priority according to the IEEE 802.1p standard.

If the connection is half duplex, deterministic access to the network depends on incoming traffic. The following embodiments of the invention address this by ensuring that there will be no conflicting incoming traffic at the intended time of access to the network. Hence these embodiments are advantageous for both half and full duplex.

Referring now to FIG. 4, an alternative embodiment will be described. This embodiment takes into account the necessity of ensuring that the port is available for transmission and not occupied by any outgoing or disabled by any incoming packet or other traffic on the transmission media. Outgoing packets must be disabled both in the case of half duplex and full duplex transmission, while the problem of incoming or other traffic relates only to half duplex, such as if the time server is transmitting on a two wire drop link or on a data bus or radio packet network where access is determined by access protocols based on traffic detection and collision detection.

In order to disable transmission from the time server and at the same prevent other nodes from sending data on the transmission media, a dummy packet is generated and placed 201 in the output queue of the port on which it is to be transmitted. The dummy packet contains a particular pattern which makes it possible to identify.

After the dummy packet is placed in the output queue, the communication port is monitored 202. As soon as the particular pattern that identifies the dummy packet is detected 203 as being transmitted on the port, the time T₀ of the local clock is read 204. Following this, a time stamp TS is generated 205 and registered as the Transmit Time Stamp of a time information packet. The time stamp is set equal to the time of the local clock recorded when transmission was disabled plus the time it takes to complete transmission of the dummy packet, plus the length of the minimum allowable time gap between packets, or

TS=T₀+T_{flush}+T_{gap} (6)

Where TS is Transmit Time Stamp, T₀ is the recorded time of the local clock when the dummy packet is detected, T_{flush} is the time required to complete transmission of the dummy packet, and T_{gap} is the minimum allowable time gap between packets. By placing the dummy packet in the output buffer 206 and making sure that no packet is queued between the dummy packet and the time information packet, the time information packet will by necessity be transmitted when the time of the local clock reaches the same value as the time stamp in the Transmit Time Stamp field of the time information packet.

Referring now to FIG. 5, an alternative embodiment will be described where the dummy packet is replaced by a busy signal. According to the Ethernet standard, such a busy signal is referred to as a back pressure signal and is normally used to prevent incoming information when the output buffers of a switch is about to overflow.

The time server enables 301 a busy signal on the communication port on which the time information packet will be transmitted. At the same time the local clock time T₀ is registered 302. Alternatively the local clock time is registered when the busy signal is detected on the communication port. Following this, a time stamp TS is generated 303. The time stamp TS is set to equal the registered time of the local clock when the busy signal was enabled or detected, T₀, plus the time the busy signal will remain enabled after the time of the local clock has been registered, plus the minimum allowable time gap between packets, or

TS=T₀+T_{busy}+T_{gap} (7)

where TS is Transmit Time Stamp, T₀ is the recorded time of the local clock when the dummy packet is detected, T_{busy} is the time the busy signal will remain enabled or will remain on after having been detected, and T_{gap} is the minimum allowable time gap between packets. The time information packet is then placed 304 in the first position of the output queue where it waits 305 until the busy signal is disabled 306. This will ensure that the time information packet is transmitted when the time of the local clock equals the time stamp in the time information packet.

It must be noted that while the first embodiment described with reference to FIG. 3 can be utilized also when the time information packet is to be transmitted on several communication ports at the same time, this is not the case with the two embodiments where access to the transmission media is ensured through the transmission of a dummy packet or a busy signal respectively. This is because the time of the local clock is registered and the transmission of the dummy packet or the busy signal is started as soon as the communication port is available and continues for a predetermined time. In the case where transmission of the time information packet will take place on several communication ports, however, there's no reason to expect that these ports will become available at the same time.

Referring now to FIG. 6, an alternative embodiment will be described, which enables the transmission of time information packets on multiple ports. As in the embodiment described with reference to FIG. 5, the time server enables 401 a busy signal, but this time on a plurality of communication ports. There are then three preferable alternatives for when the time T₀ of the local clock is read 402. It can either be read at the time the busy signal is enabled, as soon as the busy signal is detected on at least one communication port, or as soon as the busy signal is detected on all the communication ports. It is obviously possible to select any other point in time within the interval between enabling the busy signal and actually generating the time information packet, as long as the time from reading T₀ and until transmitting the time information packet is deterministic. The three alternatives mentioned are well defined, however, and are therefore preferred.

As soon as the time T₀ is read, a time stamp is generated 403. The time stamp is again given as

TS=T₀+T_{busy}+T_{gap}

where TS is Transmit Timestamp, T₀ is the recorded time of the local clock either when the busy signal is enabled, or when the busy signal is detected on one or all the communication ports, T_{busy} is the period of time through which the busy signal remains enabled after T₀ has been registered, and T_{gap} is the minimum allowable time gap between packets. If T₀ is registered when the busy signal is enabled or when it is detected on at least one port, the busy signal should remain enabled at least for a period of time T_{busy} that is as long as the time it takes to transmit a maximum size packet, or T_{busy}≧T_{flush}. This will ensure that ongoing transmission of packets will be completed and the transmission of the busy signal will have started on all the ports before the busy signals are disabled and the time information packet is transmitted. If the time of the local clock T₀ is only registered after the busy signal has been detected on all the communication ports, it is sufficient that the busy signals remain enabled only so long that the time server has sufficient time to generate the time information packets and place them in the first position of the output queues. The exact sequence of these steps are not critical, however, as long as the remaining time during which the busy signal is on is known at the time the local clock is read. (i.e. the local clock may be read prior to or following detection of the busy signal and the time information packets may be placed in output buffers or queues as the busy signals are detected on the various ports or following detection on all the ports. Which alternative is preferred in each case may depend on the architecture of the time server.) FIG. 6 illustrates an embodiment where following the detection 404 of the busy signal on all the communication ports, the time information packets are placed 405 in the output buffer. After the preset period of time has elapsed 406, the busy signal is disabled 407 simultaneously on all the communication ports.

FIG. 7 illustrates this process. The four horizontal bars in the diagram illustrates the transmission on the four different ports. At a first point in time the busy signal is enabled on all ports. This is the first point in time where the time of the local clock may be registered. If this alternative is chosen, the time T_{busy} will be as illustrated by the time line marked A. Since all the ports are busy transmitting or receiving other packets, no busy signal will yet be transmitted. When the first port, port 1, finishes the ongoing transmission, a busy signal will commence on this port. This is the second alternative for when the local clock may be read. If the local time is read at this time, T_{busy} will be as illustrated by the time line B. Both A and B will by necessity have to be longer than the total transmission time for a maximum length packet in order for all the ports to be able to finish any ongoing transmission. In the example illustrated, the last port to finish the ongoing transmission is port 2. The third alternative to when the time T₀ is read from the local clock is at or following this time, when the busy signal is detected on all the ports. In this case the time T_{busy} will be the time through which the busy signal remains enabled on all the ports, as illustrated by the time line C. Note that since the busy signal is now detected on all the ports, T_{busy} will in this case not have to be as long as the transmission time for a maximum length packet. It is sufficient that T_{busy} gives the time server enough time to place the time stamp TS in the time information packets and place them in the first position of the respective output queues. The minimum allowable time gap between packets is illustrated by the time line marked D.

The embodiment just described, which ensures that time packets can be transmitted simultaneously on several ports, is particularly useful when the time server is integrated in a switch, as described in the same applicant's co-pending application entitled “Integrated switch and time server”.

It should be noted that in the embodiments described in relation to FIGS. 4, 5 and 6, respectively, as they relate to half duplex transmission, involve a certain risk of collision. This may occur because following the end of transmission of the dummy packet or the busy signal, respectively, the time information packet must wait a period of time T_{gap} before it can be transmitted. T_{gap} is equal to the Inter Packet Gap (IPG), which is also the period of time a receiving client must wait following the end of reception of the dummy packet or busy signal. It is therefore possible that the client will begin transmission before or at the exact time when it receives the time information packet, resulting in a collision. Numerous methods for collision detection are known in the art. It is preferable that such a method is implemented in the time server and that upon detection of a collision, the process is restarted, including the transmission of a new dummy packet or busy signal and the generation of a new time information packet. The exact method selected for collision detection is dependent on factors such as the nature of the transmission medium, and is not part of this invention. The time update packet must, however, not be resent in case of a collision since the time stamp contained in the packet is no longer valid.

Referring now to FIG. 8, a time server 501 based on the invention is illustrated in a block diagram. The time server in the illustration has only one communication port 502 with an output buffer, but such a time server may also have several communication ports, which will be the case if the time server is integrated in a switch, as described in the co-pending application mentioned above. The time server further comprises a local clock 503 which can be read from processor means 504. The processor means 504 operates in accordance with instructions in a local memory means 505. These instructions will enable the processor means to operate according to some time distribution protocol, such as SNTP which has already been mentioned. Further instructions will allow the processor 504 to read the value of the local clock, generate time stamps and time information packets, generate dummy packets or busy signals, monitor the communication ports and detect collisions on the transmission medium, as is determined by the particular embodiment of the invention. In addition to the processor means 504, dedicated logic circuits can be utilized for some of these tasks, such as detection of busy signal or dummy packet, as well as collision detection, in order to increase speed.

The time server 501 will preferably also include input means 506 through which the time server may be connected to an external clock 507, such as a GPS receiver (Global Positioning System) or an atomic clock.

The transmission medium on which the time server 501 transmits, is indicated at 508, and may vary according to the circumstances.

It should be noted that while the embodiments described above primarily refer to the invention being used in relation with time servers, the method claimed in the attached claims are directed towards a method for including a time stamp in a data packet in general, and that this data packet does not have to be a time information packet as such. It should further be noted that while the examples often refer to the Ethernet protocol, this too is by way of example, and it must be understood that a person with skill in the art to which the invention pertains, will see that the invention has similar applicability to any other similar communication protocol.

1. Method for ensuring access to a transmission medium at a predetermined point in time, for the transmission of a data packet,
characterized in
making one or more communication ports on which said packet is to be transmitted unavailable for conflicting traffic for a period of time that is set to terminate at the predetermined point in time,
preparing said data packet for transmission as soon as said communication ports again are available, and
transmitting said data packet when said one or more communication ports are again made available.

2. Method according to claim 1,
characterized in that
the step of making said communication ports unavailable does not interfere with any ongoing transmission of packets, but disables any transmission of new packets, and
that the period of time for which transmission is disabled is greater than the period of time for transmitting a maximum size packet.

3. Method according to claim 1,
characterized in that
the step of making said communication ports unavailable includes enabling a busy signal that will commence transmission on the communication ports as soon as any ongoing transmission or reception on the respective port is completed and will continue until the time remaining before said predetermined period in time equals the minimum allowable time gap between subsequent packets, and
the step of transmitting the data packet includes preparing the packet for transmission upon the termination of the busy signal.

4. Method for including a time stamp in a data packet, said time stamp indicating the time of a local clock at the moment said packet is transmitted,
characterized in
making one or more communication ports on which said packet is to be transmitted unavailable for data traffic,
generating a data packet including a time stamp equal to a recorded time of the local clock plus the remaining period of time for which said communication ports will be unavailable,
preparing said data packet for transmission as soon said communication ports again are available, and
transmitting said data packet when said one or more communication ports are again made available, at a point in time corresponding to the time stamp in the data packet.

5. Method according to claim 4,
characterized in that
the step of making said communication ports unavailable does not interfere with any ongoing transmission of packets, but disables any transmission of new packets, and
that the period of time for which transmission is disabled is greater than the period of time for transmitting a maximum size packet.

6. Method according to claim 4,
characterized in that
the step of making the communication ports unavailable includes transmitting on said communication ports, a dummy packet with a predetermined pattern,
the step of generating a data packet with a time stamp includes detecting said predetermined pattern on said one or more communication ports, recording the time of the local clock at the time said pattern is detected and creating a time stamp equal to the recorded time of the local clock plus the remaining time for transmitting the rest of the dummy packet plus the minimum allowable time gap between subsequent packets, and
the step of transmitting the data packet includes preparing the packet for transmission upon completion of transmission of the dummy packet.

7. Method according to claim 4,
characterized in that
the step of making said communication ports unavailable includes enabling a busy signal that will commence transmission on the communication ports as soon as any ongoing transmission or reception on the respective port is completed and will continue for a predetermined period of time,
the step of generating a data packet with a time stamp includes recording the time of the local clock at the time said busy signal is enabled or at the time said busy signal is detected on any or all of the communication ports, and creating a time stamp equal to the recorded time of the local clock plus the predetermined time plus the minimum allowable gap between subsequent packets, said predetermined time starting from the time at which the local clock is read, and
the step of transmitting the data packet includes preparing the packet for transmission upon the termination of the busy signal.

8. Method according to claim 4,
characterized in that
the step of making said communication ports unavailable includes enabling a busy signal that will commence transmission on the communication ports as soon as any ongoing transmission or reception on the respective port is completed and will continue for a predetermined period of time,
the step of generating a data packet with a time stamp includes recording the time of the local clock at the time said busy signal is enabled or at the time said busy signal is detected on one communication port or when the busy signal is detected on all the communication ports, and creating a time stamp equal to the recorded time of the local clock plus the predetermined time plus the minimum allowable gap between subsequent packets, said predetermined time starting from the time at which the local clock is read, and
the step of transmitting the data packet includes preparing the packet for transmission upon the termination of the busy signal.

9. Time server for distributing time information packets on a computer network, comprising one or more communication ports with output buffers for transmitting time information packets onto said computer network, a local clock,
characterized in further comprising
means for making said communication ports on which time information packets are to be transmitted, unavailable for any communication that is not already ongoing,
processor means for reading a local time from the local clock, generating a time stamp equal to the time read from the local clock plus the time remaining during which the communication port will be unavailable, generating a time information packet including said time stamp, and placing said time information packet in the output buffers for transmission immediately upon termination of the period of time during which the communication port is unavailable.

10. Time server according to claim 9,
characterized in that it further comprises
input means for receiving time signals from an external clock, and means for adjusting the local clock in accordance with said time signals.

11. Time server according to claim 9,
characterized in that the means for making said communication ports unavailable for traffic include means for disabling the entry of any other packet than said time information packet into the output buffer, and that said means are set to maintain this condition for a period of time that is at least equal to the time it takes to transmit a maximum size packet.

12. Time server according to claim 9,
characterized in that
the means for making said communication ports unavailable for traffic include means for generating a dummy packet containing a predetermined pattern, means for placing said dummy packet in the output buffer of an output port pending transmission, and means for monitoring the communication port in order to detect said predetermined pattern as an indication that the dummy packet is being transmitted and signal this detection to the processor means, wherein
the processor means based on said signal is able to determine the time at which the communication port again will become available based on the period of time it takes to complete transmission of the dummy packet upon detection plus the minimum allowable time gap between packets.

13. Time server according to claim 9,
characterized in that
the means for malting said communication ports unavailable for traffic include means that subsequent to being enabled will generate a busy signal that will be transmitted on the communication ports as soon as any ongoing transmission or reception on the respective port is completed and that will continue for a predetermined period of time, and optionally means for detecting the busy signal on any or all of the communication ports and signal this detection to the processor, wherein
the processor means based on the point in time at which the means for generating the busy signal are enabled, or optionally at the point in time at which it receives a signal indicating that any or all busy signals have been detected, is able to determine the time at which the communication port again will become available based on the period of time the busy signals are set to continue plus the minimum allowable time gap between packets.

14. Time server according to claim 9,
characterized in that it further comprises collision detection means for detection collisions between outgoing and incoming traffic on the communication ports.

15. Time server according to one of the claims 9 to 14,
characterized in that it further comprises memory means containing instructions to the processor means, and that said instructions together with the processor means may constitute wholly or partly, the various other means of the time server.
